(19) United States
(12) Patent Application Publication
(10) Pub. No.: US 2024/0364784 A1
(43) Pub. Date: Oct. 31, 2024

(54) METHOD AND SYSTEM TO MEASURE SERVICE USAGE AND BILL FOR ASSOCIATED USED SERVICES BASED ON A INTRUSION DETECTION SYSTEM

(71) Applicant: Robert Bosch GmbH, Stuttgart (DE)

(72) Inventors: Tobias GEHRMANN, Stuttgart (DE); Jorge GUAJARDO MERCHAN, PITTSBURGH, PA (US)

(21) Appl. No.: 18/139,678

(22) Filed: Apr. 26, 2023

(51) Int. Cl. H04L 67/12; G07C 5/08; H04L 12/40

(52) U.S. Cl. CPC H04L 67/12; G07C 5/0808; H04L 12/40; G07C 2205/02; H04L 2012/40215

(57) ABSTRACT

A system includes one or more sensors in a vehicle configured to collect a first set of signal data indicative of controller area network traffic of a CAN network in a controlled environment and a second set of signal data indicative of controller area network traffic of a CAN network during vehicle operation. The system further includes a processor programmed to send both the first set of signal data and the second set of signal data to a remote server, identify correlations associated with the first set of signal data to establish a correlation list, comparing the second set of signal data to the correlations list associated with the first set of signal data, and in response to correlations of the second set of signal data exceeding a threshold defining normal operation, sending an alert to a remote agency indicating tampering associated with the second set of signal data.

### TECHNICAL FIELD

The present disclosure relates to intrusion detection systems, such as those that operate in a vehicle.

### BACKGROUND

CAN bus is the central communication network in several modern systems such as automotive systems, aerospace systems, industrial systems, etc. Some of the nodes on the CAN bus, and more generally on the internal network of the vehicle, may be equipped with remote interfaces. Such interfaces may often be used to enable over-the-air updates, offer additional services, measure usage of applications, and measure usage of certain functions in the ECU to enable maintenance services, etc.

Pay-as-you-drive insurance models are becoming more present in systems. To enable this, vehicles may be equipped with additional dongles to measure data and send this data to a remote server for further processing, or an app may be downloaded to the phone of the driver to monitor phone usage while driving. Examples of applications enabled like this may include pay-as-you-drive insurance. In the particular case of pay-as-you-drive insurance, the data collected might be combined with map data to correlate the driving behavior with road conditions, signs, etc., so as to classify the driver as a safe or unsafe driver and thus charge them accordingly.

The automotive industry may also utilize a pay-per-use model. The service provider may be offering a particular function to download a new feature to the vehicle as a software update and charge the user accordingly for their use. The users may pay for a period of time for the enabled function and after a certain time, this function may be disabled. Furthermore, the vehicles may have systems that can detect attacks (e.g. cybersecurity attacks), sometimes called Intrusion Detection Systems (“IDS”). The automotive system of modern vehicles may be equipped with a large number of electronic control units (ECUs) connected by a network using CAN, automotive Ethernet, or other network technology. These ECUs may control the vehicle by running more and more complex software. Furthermore, network connectivity has been increasing further because of sensor data, such as camera streams or LIDAR. The resulting automotive system may be becoming an increasingly attractive target for adversaries interested in compromising this system. Manipulation of network traffic or process changes on an ECU pose various threats to vehicles and passengers, traffic participants and to the vehicle itself.

IDS adoption may be driven by an increase in attack in the vehicle and the likelihood of attacks that may have a potential for safety implications. Because of this, new regulations have been enacted (e.g., WP29, RF155), which will require vehicles to have IDS's that can detect and potentially react to an attack. An IDS aims at detecting such a compromise and may collect all kinds of automotive data to verify consistency and ensure integrity of network traffic and command and control. Recent IDS solutions send such data to a cloud backend for further processing.

### SUMMARY

A first embodiment discloses a computer-implemented method that includes receiving a first set of an in-vehicle network signal data indicative of in-vehicle network traffic of an in-vehicle network in a controlled environment, finding correlations associated with the first set of in-vehicle signal data and storing the correlations in a correlation list that is indicative of communication characteristic amongst signals in the first set of in-vehicle signal data, sending the correlation list to a first remote server associated with a service agency, receiving a second set of in-vehicle network signal data indicative of in-vehicle traffic of the in-vehicle network during normal vehicle operation, sending the second set of in-vehicle network signal data to a second remote server associated with the service agency, and in response to comparing the correlation list and the second set of in-vehicle network signal data, and the comparison indicating communication characteristics exceeding a threshold amount of change, outputting an alert indicating tampering associated with the second set of in-vehicle signal data for a duration of time and identifying a cost associated with the tampering utilizing the second set of in-vehicle network signal data.

A second embodiment discloses, a system includes one or more sensors in a vehicle configured to collect a first set of signal data indicative of controller area network traffic of a CAN network in a controlled environment and a second set of signal data indicative of controller area network traffic of a CAN network during vehicle operation. The system further includes a processor programmed to send both the first set of signal data and the second set of signal data to a remote server, identify correlations associated with the first set of signal data to establish a correlation list, comparing the second set of signal data to the correlations list associated with the first set of signal data, and in response to correlations of the second set of signal data exceeding a threshold defining normal operation, sending an alert to a remote agency indicating tampering associated with the second set of signal data.

A third embodiment discloses a computer-implemented method that includes receiving a first set of an in-vehicle network signal data indicative of in-vehicle network traffic of an in-vehicle network in a controlled environment, finding correlations associated with the first set of in-vehicle signal data and storing the correlations in a correlation list that is indicative of communication characteristic amongst signals in the first set of in-vehicle signal data, sending information indicative of the correlation list to a remote server associated with a service agency, receiving a second set of in-vehicle network signal data indicative of in-vehicle traffic of the in-vehicle network during normal vehicle operation, sending the second set of in-vehicle network signal data to the remote server associated with the service agency, and in response to comparing the correlation list and the second set of in-vehicle network signal data, and the comparison indicating communication characteristics exceeding a threshold amount of change, outputting an alert indicating activation of a vehicle function or tampering associated with the second set of in-vehicle signal data for a duration of time, wherein the remote server is configured to identify a cost associated with the activation of the vehicle function or the tampering utilizing at least the second set of in-vehicle network signal data.

### BRIEF DESCRIPTION OF THE DRAWINGS

FIG. 1 illustrates a block diagram of an exemplary computing device, according to some embodiments of the disclosure.

FIG. 2 illustrates a flowchart of an embodiment that includes data processing of the intrusion detection system.

FIG. 3 illustrates a plug-in device embodiment for an intrusion detection system.

FIG. 4A illustrates an illustrative flow chart for granular billing measurement for sending data over the vehicle network.

FIG. 4B includes an illustrative flow chart that utilizes fine granular billing measurements that does not send data over a vehicle network.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Current telematics car insurance methods may rely on different devices to track driving behavior, such as the driving behavior in real time. There are diagnostic port plug-in devices, mobile apps, or Bluetooth beacons. However, such options come with several disadvantages. The plug-in devices may be a dedicated, separate device with possible fees associated with them for renting or data transmission. A mobile app can not always tell who is the driver and one may occasionally need to dispute the data. For pay-per-use features, a user may need a subscription or pay a certain amount over a set period in time for a service. However, such methods do not take in account if one is using the feature at all or for how long.

In this disclosure, the system may re-purpose IDS collected data and thus, the IDS service to offer billing for other services such as telematics insurance and pay-per-use features. Such an approach has advantages. First, one advantage may be the use available IDS data as base for its billing avoids separate devices or apps for data gathering. Second, it increases flexibility in feature usage recognition. Deriving automatically by the IDS data if and how long a feature was used decreases the need of fixed subscriptions. It allows to use different sources of information to verify that a particular feature is being used, thus if a certain signal or data is missing, we can still provide accurate billing by looking at other co-related vehicle data

It allows to provide fine-grained billing services, by charging per mile or kilometer usage of the feature rather than for a fixed period of time (analogous to cloud services that charge for the exact amount of bandwidth used or the exact number of CPU cycles used). In one embodiment, the system may use data from the in-vehicle network or ECU that may allow the system to measure how many resources in the network or ECU have been used and based on that charge the customer. This may allow for reduce computational resources or time being required to transmit data used for billing or IDS purposes to the service (billing) provider. This can be achieved because not all the data will need to be protected with cryptographic means or transmitted via a fully secure channel. This may allow the system and method to be somewhat privacy preserving by not having to send all data to the billing service normally sent to the service (which can be used to derive privacy preserving information not required for billing).

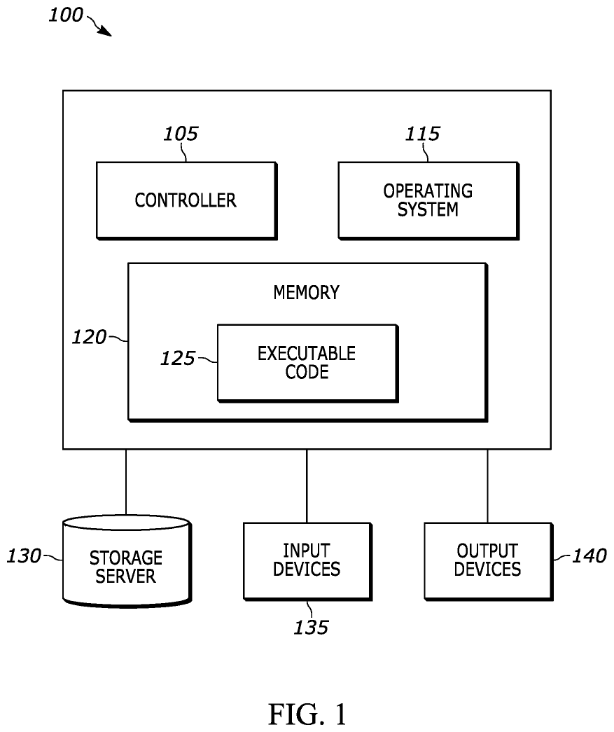

As shown in FIG. 1, which shows a block diagram of an exemplary computing device, according to some embodiments of the disclosure. A device 100 may include a controller 105 that may be, for example, a central processing unit processor (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of, a system according to embodiments of the invention.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component, e.g., in some embodiments, a system may include a computing device that does not require or include an operating system 115. For example, a computer system may be, or may include, a microcontroller, an application specific circuit (ASIC), a field programmable array (FPGA), network controller (e.g., CAN bus controller), associated transceiver, system on a chip (SOC), and/or any combination thereof that may be used without an operating system.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be an application that enforces security in a vehicle as further described herein, for example, detects or prevents cyber-attacks on in-vehicle networks. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein. Where applicable, the terms “process” and “executable code” may mean the same thing and may be used interchangeably herein. For example, verification, validation and/or authentication of a process may mean verification, validation and/or authentication of executable code.

Storage system 130 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a nonvolatile memory having the storage capacity of storage system 130. Accordingly, although shown as a separate component, storage system 130 may be embedded or included in memory 120.

Input devices 135 may be or may include any suitable input devices, components or systems, e.g., physical sensors such as accelerometers, tachometers, thermometers, microphones, analog to digital converters, etc., a detachable keyboard or keypad, a mouse and the like. Output devices 140 may include one or more (possibly detachable) displays or monitors, motors, servo motors, speakers and/or any other suitable output devices. Any applicable input/output (I/O) devices may be connected to computing device 100 as shown by blocks 135 and 140. For example, a wired or wireless network interface card (NIC), a universal serial bus (USB) device, JTAG interface, or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like. Input and/or output devices or components 135 and 140 may be adapted to interface or communicate, with control or other units in a vehicle, e.g., input and/or output devices or components 135 and 140 may include ports that enable device 100 to communicate with an engine control unit, a suspension control unit, a traction control and the like.

Embodiments may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

In some embodiments, a system may include or may be, for example, a plurality of components that include a respective plurality of central processing units, e.g., a plurality of CPUs as described, a plurality of CPUs embedded in an on board, or in-vehicle, system or network, a plurality of chips, FPGAs or SOCs, microprocessors, transceivers, microcontrollers, a plurality of computer or network devices, any other suitable computing device, and/or any combination thereof. For example, a system as described herein may include one or more devices such as computing device 100.

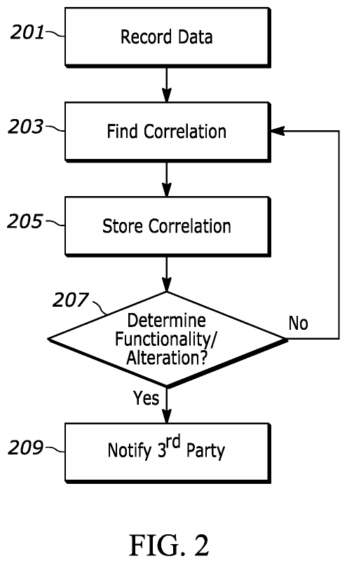

FIG. 2 discloses a flowchart of an embodiment that includes general data processing. At an overview, an automotive IDS may be utilized to collect automotive signal data, as well as detected security events that are sent to a backend for further processing. For example, if a signal or group of signals appear to be a deviations from traditional communication signals, such data may be sent off-board for processing to determine if a security threat or event is taken place. The automotive signal data can include all the vehicle network traffic on the vehicle network (e.g., CAN traffic on the CAN network) for a particular period of time. For example, the signal data may be referred to as a set of values S=S1, S2, S3, . . . , Sn in no particular order.

The signals may be determined if a correlation exists. Such signals may be correlated and thus there may be a linear or non-linear relation among some of these signals that can be calculated. For example, assume that signals S1, S2, S3 are used by a billing application already and that all signals in the set S are used and collected for the IDS. It may be relatively easy to derive correlations between such signals by analyzing data from the in-vehicle network.

The billing may be accomplished in a manner as such. At step 201, the system may record data from the in-vehicle network that will be used for the IDS resulting in a set of signals S={S1, S2, S3, . . . , Sn}. The signals may be any number of signals. Furthermore, the signals may be collected at a given time period or duration. The signals may be collected utilizing sensors or other types of devices and instruments.

At step 203, the system may find correlations (e.g., such as linear) between signals in the set S, Upon finding the correlations, the system may store them into a list R=R1, R2, R3, . . . . Rp. R may be a list of the correlations found in the set of signals S. This could be represented as Ri={Si, Sj, . . . , St; correlation information} where correlation information could be, for example, the coefficients of a linear regression model computed on signals Si, Sj, . . . . St where {Si, Sj, . . . . St} is a subset of S. Another way to compute a correlation could be by computing the Pearson correlation coefficient ρ for pairs of signals {(S1, S2), (S2, S3), (S3, S4), . . . (Si, Sj)} for i≠j, which may allow for the computation:

$$ρ = \frac{{\sum }_{i = 1}^{n} ( {x}_{i} - \overline{x} ) ( {y}_{i} - \overline{y} )}{\sqrt{{\sum }_{i = 1}^{n} {( {x}_{i} - \overline{x} )}^{2}} \sqrt{{\sum }_{i = 1}^{n} {( {y}_{i} - \overline{y} )}^{2}}}$$

where n is sample size, xᵢyᵢ are the individual sample signals indexed with i,

$$\overline{x} = \frac{1}{n} {\sum }_{i = 1}^{n} {x}_{i}$$

is the sample mean; and analogously for y̅. For continuous signals, the computation of the Pearson coefficient can be performed on a subset of sample points corresponding to a subset of the sample points (corresponding to a “window” of sample points, where the window size has been pre-defined). Other methods that could be used include time lagged cross correlations, dynamic time warping.

At step 205, the system may store the list of correlations with respect to the signals. The list R with signals and correlation information may be stored in a secure manner in the backend remote server. For example, the list with signals and correlation information may be stored on a read only access device or an encrypted portion of storage. Thus, security measures may be utilized to ensure the correlation list is secure. In some cases only the correlation information may need to be stored. During operation of the vehicle, signal data from the CAN network of the car may be collected resulting in a set of signals S′={S1′, S2′, S3′, . . . , Sn′}. The assumption may be that at least a subset of signals in S′ can be collected (recorded at their source) and transmitted to a backend in a secure and tamper proof manner. The system may send a small subset of signals (e.g., “Sinsurance”) to the insurance provider so that the insurance provider can perform their billing.

At decision 207, the system may determine if any functionality was executed or an alteration of data occurred. The system may utilize the correlation list and compare it to the subset of signals selected. At step 209, the system may, at a later time, provide information to the billing provider, or a law enforcement agent that can come with a claim indicating that the data that was sent to them had somehow tampered with. For example, the information may indicate that the signals or data may not be the original data that was collected from the in-vehicle network, and was altered or contrived in order to evade abusive operation of the vehicle. The system may use the vehicle operation signals S′ and the correlations securely stored in R and compute how close to the relations stored in R are to the vehicle operation signals in S′ are. If the results are above a certain threshold then the system may decide that the signals used for billing have not been tampered with and report to the billing provider or law enforcement provider that their claim is not correct. Otherwise, the system may report that the claim has grounds and that they need to take an appropriate action. For example, the system may be programmed to define a threshold of normalcy and if the relations exceed it, it may consider that the system is tampered with.

Another advantage of such a system may be that the system may have the ability to use correlations from signals not originally collected. Thus, the billing service provider may use the correlations from signals not originally collected by the billing service provider to verify that the signals that are used to provide billing has not been tampered with. Another advantage may be that the system does not need to send all data to the billing provider, but only a subset of data that is collected from the vehicle (e.g. CAN network). Another advantage might be that based on the subset of signals sent to the backend, the full set of signals is reconstructed in the backend to provide a billing service or IDS service. This reconstruction can be accomplished via a previously trained Generative Adversarial Network (GAN) that takes as input the subset of signals sent to the backend and outputs the full set of signals needed for billing. This may be advantageous to reduce bandwidth and to protect privacy of the driver whose data is collected.

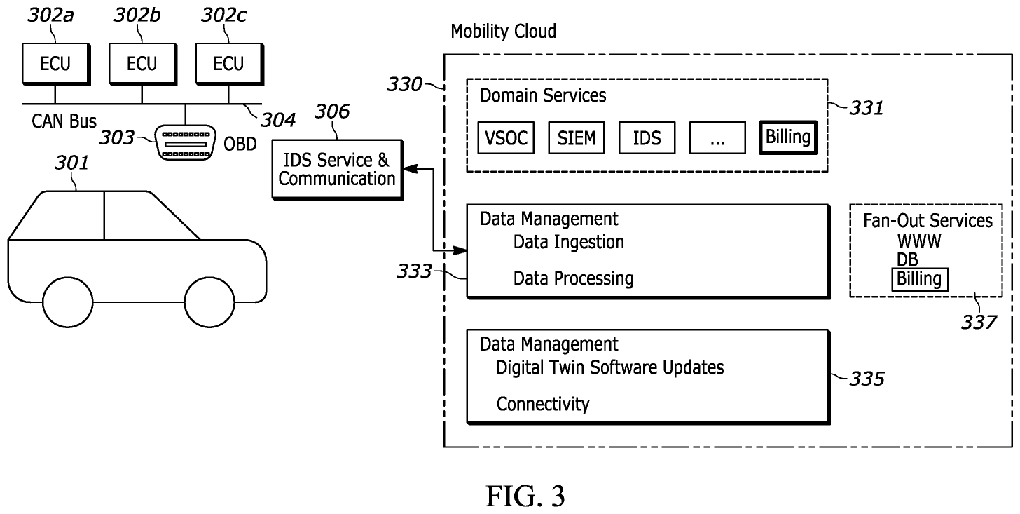

FIG. 3 discloses an embodiment that may utilize a plug-in device at the vehicle. A possible implementation of an IDS includes a device that is plugged into the diagnostic port 303 (OBD-II Port) of a vehicle and records CAN messages. Security related CAN messages may be sent to a cloud backend where they are stored in a database and are available for visualization, further processing or accessible for external services.

Data necessary for telematics car insurance like acceleration, braking, cornering or mileage are part of these security related telemetry messages. The security related telemetry data includes lower level signals of pay-per-use features, such as steering wheel heating or autonomous driving. Since this data is already available and does not have to be gathered separately, it can be made available to the billing services of a provider. Depending on where the cloud backend is hosted, on premise or at a service provider, this can be achieved by providing a domain service or an externally available API to the database.

The remote server 330 may be in communication with the vehicle 301. The remote server may utilize domain services 331 to store centralized information. For example, the domain services 331 may have directory information to let users and domains communicate. The domain services may include information related to a virtual security operating center (VSOC), security incident and event management system (SIEM), intrusion detection system, billing, etc.

The remote server 330 may include a data management system 333. The data management system 333 may include information associated with data ingestion (e.g., storing data received from the vehicle, types of data to retrieve from the vehicle), as well as processing of such data. The server 330 may also include a device management system 335. The device management system 335 may include digital twin software updates. A digital twin may be a virtual model designed to accurately reflect a physical object. The object being studied—for example, a vehicle or external plug in device for the diagnostic port of the vehicle—may be outfitted with various sensors related to vital areas of functionality. These sensors may produce data about different aspects of the physical object's performance, such as energy output, temperature, weather conditions and more. This data may then be relayed to a processing system and applied to the digital copy. Once informed with such data, the virtual model can be used to run simulations, study performance issues and generate possible improvements, all with the goal of generating valuable insights-which can then be applied back to the original physical object. There may be various software updates associated with the digital twin. The server may also include a fan-out services system 337. A fan-out may be a messaging pattern used to model an information exchange that implies the delivery (or spreading) of a message to one or multiple destinations possibly in parallel, and not halting the process that executes the messaging to wait for any response to that message

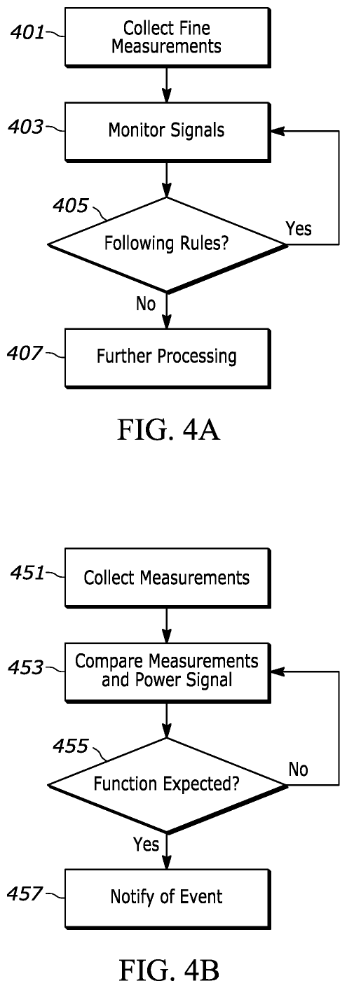

FIG. 4A includes an illustrative flow chart for granular billing measurement for sending data over the vehicle network. In another embodiment, the system may collect fine-granular measurements at step 401. In one example, a way to get a more fine granular measurement of when a particular feature is used could be as simple as monitoring the feature effect on CAN signals. For example, if a feature is expected to send one or more CAN signals on the CAN bus, the IDS can simply monitor the signals (at step 403) and how often they happen according to some pre-defined rules. At decision 405, the IDS may determine if the collected signals are following rules or not. If the rules are being followed, the system may continue to monitor the signals. However, at step 407, if the IDS sees that the rules are not being followed, then it can raise an event that is sent to the backend for further processing. In this case, all the CAN data does not need to be sent to the backend but only events monitored by the IDS which greatly reduces the amount of CAN data that is sent to the backend. Only the events need to be sent to the billing service. The frequency of events can be used to simply monitor when a particular feature is used. The frequency of events will dictate the granularity of billing information that can be processed and therefore how fine granular the billing can be provided.

FIG. 4B includes an illustrative flow chart that utilizes fine granular billing measurements that does not send data over a vehicle network. In cases of applications that only act at the ECU level, one way to provide fine granular measurements of usage can be implemented by making use of a power consumption measurement collected during the normal execution of programs in an automotive ECU. At step 451, the system may collect such power consumption measurements utilizing the IDS. This may be accomplished in the same manner as a power-based IDS disclosed in U.S. patent application Ser. No. 16/723,861 titled “SYSTEM AND METHOD FOR NETWORK INTRUSION DETECTION BASED ON PHYSICAL MEASUREMENTS” and U.S. Pat. No. 11,354,411 titled “MICROCONTROLLER PROGRAM INSTRUCTION EXECUTION FINGERPRINTING AND INTRUSION DETECTION”, which is hereby incorporated by reference in its entirety. The present system may include some minor variations and differences. Instead of trying to identify malicious software (e.g., create signatures of known malicious software such as virus software) as compared to non-modified software, the system may monitor when a certain function is performed utilizing the measurements. The system may include a correlation list of functions to see if the software has been modified at all. Thus, the system may operate knowing what to expect in terms of functionality (because, for example, the system was created and burned the software onto the ECU during production and recorded the power consumption signature of the expected software running) and then verifying that the software is still that what is expected (based on the power consumption signature). during usage of the car.

In another embodiment, the correlation list may also be utilized to identify functions that may be considered hazardous in driving. Such functions may include disabling an existing function, adding a function that sends data continuously on the CAN bus so as to monopolize its use and effectively cause a denial of service attack, add a function that sends information that a particular ECU is not supposed to send (i.e., messages that would be sent by a different ECU), stop sending periodic signals that are meant to increase the safety of the automotive system (for example, if a driver is pressing the brake pedal, the signal that is sent to the ECU controlling the brakes is a continuous signal over a period of time, so that periodic signal could be interrupted), etc., Thus at step 453, the system may compare the measurements of the power consumption signals to that of the listed functions. Thus, instead of monitoring for all functions and classifying them as malicious or non-malicious, the system may only have to detect if a particular function is executed. At decision 455, the system may determine if a particular function is executed that an entity should be notified about for a pay-as-you-use application. The system may determine that a particular function is executed based on its power consumption signature for that specific function. Thus, if the power consumption matches the signature, it can be presumed that the function has been activated. An alternative embodiment, would also including using the IDS to make sure that the software has not been tampered with and thus if the system is untampered, every time you execute the software you run a particular function as well. Thus, the system may simply count the number of times the particular software function has been executed as part of the overall software stack. At step 457, the system can send an event to the backend server or the system can send a window of the execution measurement together with a time stamp that may be later retrieved to identify execution of the function and when it occurred.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method, comprising:
receiving a first set of an in-vehicle network signal data indicative of in-vehicle network traffic of an in-vehicle network in a controlled environment;
finding correlations associated with the first set of in-vehicle signal data and storing the correlations in a correlation list that is indicative of communication characteristic amongst signals in the first set of in-vehicle signal data;
sending the correlation list to a first remote server associated with a service agency;
receiving a second set of in-vehicle network signal data indicative of in-vehicle traffic of the in-vehicle network during normal vehicle operation;
sending the second set of in-vehicle network signal data to a second remote server associated with the service agency; and
in response to comparing the correlation list and the second set of in-vehicle network signal data, and the comparison indicating communication characteristics exceeding a threshold amount of change, outputting an alert indicating tampering associated with the second set of in-vehicle signal data for a duration of time and identifying a cost associated with the tampering utilizing the second set of in-vehicle network signal data.

2. The method of claim 1, wherein the communication characteristics amongst signals includes a rate of change between types of signals in the first set.

3. The method of claim 1, wherein the communication characteristics amongst signals includes a frequency change between types of signals in the first set.

4. The method of claim 1, wherein the second set of in-vehicle signal data is retrieved from a plug-in device inserted into a diagnostic port of the vehicle, wherein the plug-in device records in-vehicle messages communicated in the vehicle.

5. The method of claim 1, wherein the remote agency includes an insurance agency or police agency.

6. The method of claim 1, wherein the duration of time includes a start time and an end time.

7. The method of claim 1, wherein the in-vehicle network includes a Controller Area Network (CAN).

8. The method of claim 1, wherein in response to correlations of the second set of CAN signal data being below a threshold amount, not sending an alert to a remote agency indicating tampering associated with the second set of CAN signal data.

9. The method of claim 1, wherein the correlations include information associated with coefficients of a linear regression model computer on the first set of CAN signal data.

10. The method of claim 1, wherein first remote server and the second remote server are a same server or a different server.

11. A system, comprising:
one or more sensors in a vehicle, the one or more sensors configured to collect a first set of signal data indicative of controller area network traffic of a CAN network in a controlled environment and a second set of signal data indicative of controller area network traffic of a CAN network during vehicle operation;
a processor in communication with the one or more sensors, the processor programmed to:
send both the first set of signal data and the second set of signal data to a remote server;
identify correlations associated with the first set of signal data to establish a correlation list;
comparing the second set of signal data to the correlations list associated with the first set of signal data;
in response to correlations of the second set of signal data exceeding a threshold defining normal operation, sending an alert to a remote agency indicating tampering associated with the second set of signal data.

12. The system of claim 11, wherein the system includes an external plug-in device configured to plug into a diagnostic port associated with the vehicle and records both the first set of signal data and the second set of signal data.

13. The system of claim 11, wherein the correlations include information associated with coefficients of a linear regression model on the first set of signal data.

14. The system of claim 11, wherein the second set of data is collected via a plug-in device connected to an OBD-II Port of the vehicle.

15. A computer-implemented method, comprising:
receiving a first set of an in-vehicle network signal data indicative of in-vehicle network traffic of an in-vehicle network in a controlled environment;
finding correlations associated with the first set of in-vehicle signal data and storing the correlations in a correlation list that is indicative of communication characteristic amongst signals in the first set of in-vehicle signal data;
sending information indicative of the correlation list to a remote server associated with a service agency;
receiving a second set of in-vehicle network signal data indicative of in-vehicle traffic of the in-vehicle network during normal vehicle operation;
sending the second set of in-vehicle network signal data to the remote server associated with the service agency; and
in response to comparing the correlation list and the second set of in-vehicle network signal data, and the comparison indicating communication characteristics exceeding a threshold amount of change, outputting an alert indicating activation of a vehicle function or tampering associated with the second set of in-vehicle signal data for a duration of time, wherein the remote server is configured to identify a cost associated with the activation of the vehicle function or the tampering utilizing at least the second set of in-vehicle network signal data.

16. The method of claim 15, wherein the second set of data is collected via a plug-in device connected to an OBD-II Port of a vehicle.

17. The method of claim 15, wherein the communication characteristics amongst signals includes a frequency change between types of signals in the first set.

18. The method of claim 15, wherein the second set of in-vehicle signal data is retrieved from a plug-in device inserted into a diagnostic port of the vehicle, wherein the plug-in device records in-vehicle messages communicated in the vehicle.

19. The method of claim 15, wherein the comparing of the correlation list and the second set of in-vehicle network signal data occurs at the remote server.

20. The method of claim 15, wherein the in-vehicle network includes a Controller Area Network (CAN).
